(19) United States
(12) Patent Application Publication
(10) Pub. No.: US 2024/0396626 A1
(43) Pub. Date: Nov. 28, 2024

(54) METHODS, COMMUNICATIONS DEVICE AND INFRASTRUCTURE EQUIPMENT FOR A NON-TERRESTRIAL NETWORK

(71) Applicant: Sony Group Corporation, Tokyo (JP)

(72) Inventors: Samuel Asangbeng ATUNGSIRI, Basingstoke (GB); Martin Warwick BEALE, Basingstoke (GB)

(73) Assignee: Sony Group Corporation, Tokyo (JP)

(21) Appl. No.: 18/693,170

(22) PCT Filed: Sep. 22, 2022
(86) PCT No.: PCT/EP2022/076435

§ 371 Date: Mar. 19, 2024

(30) Foreign Application Priority Data
Sep. 30, 2021 (EP) 21200375.0

(51) Int. Cl. H04B 7/185

(52) U.S. Cl. CPC H04B 7/18523; H04B 7/18532; H04B 7/18545

(57) ABSTRACT

A method of operating a communications device configured to transmit uplink signals to and/or to receive downlink signals from a non-terrestrial infrastructure equipment forming part of a non-terrestrial network, the method comprising: reading a first broadcast at a first reception time, wherein the first broadcast includes first signalling information comprising: first motion information of the non-terrestrial infrastructure equipment, and expiration information, wherein the expiration information is indicative of an invalidity time at which the first motion information will be deemed to be invalid; determining that the first motion information has become invalid; and based on determining that the first motion information has become invalid, receiving a second broadcast, wherein the second broadcast includes second signalling information comprising second motion information of the non-terrestrial infrastructure equipment and expiration information.

The present application claims the Paris Convention priority of European patent application EP21200375.0, filed 30 Sep. 2021, the contents of which are hereby incorporated by reference.

### BACKGROUND

### Field

The present disclosure relates generally to communications devices, infrastructure equipment and methods of operating communications devices and infrastructure equipment, and specifically to providing information regarding non-terrestrial infrastructure of a non-Terrestrial Network, NTN, to a communications device.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Third and fourth generation mobile telecommunication systems, such as those based on the third generation partnership project (3GPP) defined UMTS and Long Term Evolution (LTE) architectures, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will therefore be expected to routinely and efficiently support communications with a wider range of devices associated with a wider range of data traffic profiles and types than current systems are optimised to support. For example it is expected that future wireless communications networks will efficiently support communications with devices including reduced complexity devices, machine type communication (MTC) devices, high resolution video displays, virtual reality headsets and so on. Some of these different types of devices may be deployed in very large numbers, for example low complexity devices for supporting the “Internet of Tings”, and may typically be associated with the transmission of relatively small amounts of data with relatively high latency tolerance.

In view of this there is expected to be a desire for future wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles. There is similarly expected to be a desire for such connectivity to be available over a wide geographic area.

One example area of current interest in this regard includes so-called “non-terrestrial networks”, or NTN for short. The 3GPP has proposed in Release 15 of the 3GPP specifications to develop technologies for providing coverage by means of one or more antennas mounted on an airborne or space-borne vehicle [1].

Non-terrestrial networks may provide service in areas that cannot be covered by terrestrial cellular networks (i.e. those where coverage is provided by means of land-based antennas), such as isolated or remote areas, on board aircraft or vessels) or may provide enhanced services in other areas. The expanded coverage that may be achieved by means of non-terrestrial networks may provide service continuity for machine-to-machine (M2M) or ‘internet of things’ (IoT) devices, or for passengers on board moving platforms (e.g. passenger vehicles such as aircraft, ships, high speed trains, or buses). Other benefits may arise from the use of non-terrestrial networks for providing multicast/broadcast resources for data delivery.

The use of different types of network infrastructure equipment and requirements for coverage enhancement give rise to new challenges for efficiently handling communications in wireless communications systems that need to be addressed.

### SUMMARY

Aspects of the invention are defined in the appended claims.

According to one aspect, there is provided a method of operating a communications device configured to transmit uplink signals to and/or to receive downlink signals from a non-terrestrial infrastructure equipment forming part of a non-terrestrial network, NTN, the method comprising: reading a first signalling information broadcast at a first reception time by an infrastructure equipment, wherein the first signalling information broadcast includes first signalling information comprising: first motion information of the non-terrestrial infrastructure equipment, and expiration information, wherein the expiration information is indicative of an invalidity time at which the first motion information will be deemed to be invalid; determining that the first signalling information has become invalid; and based on determining that the first signalling information has become invalid, receiving a second signalling information broadcast, wherein the second signalling information broadcast includes second signalling information comprising second motion information of the non-terrestrial infrastructure equipment, and second expiration information, wherein the second expiration information is indicative of an invalidity time at which the second motion information will be deemed to be invalid.

According to another aspect, there is provided a method of operating infrastructure equipment forming part of a non-terrestrial network, NTN, the method comprising: generating first motion information of the non-terrestrial infrastructure equipment; determining expiration information for the first motion information, wherein the expiration information is indicative of an invalidity time at which the first motion information will be deemed to be invalid; commencing repeated broadcasting of the first signalling information, wherein a first signalling information broadcast includes first signalling information comprising: the first motion information, and the expiration information; generating second motion information of the non-terrestrial infrastructure equipment, determining second expiration information for the second motion information, wherein the second expiration information is indicative of an invalidity time at which the second motion information will be deemed to be invalid; and commencing repeated broadcasting of the second signalling information, wherein the second signalling information broadcast includes second signalling information comprising: the second motion information and the second expiration information.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device configured in accordance with example embodiments;

FIG. 4 is reproduced from [1], and illustrates a first example of a non-terrestrial network (NTN) based on a satellite/aerial platform with a bent pipe payload;

FIG. 5 is reproduced from [1], and illustrates a second example of an NTN based on a satellite/aerial platform that incorporates a gNodeB;

FIG. 6 schematically shows an example of a wireless communications system comprising an NTN part and a terrestrial network (TN) part which may be configured to operate in accordance with embodiments of the present disclosure;

FIG. 7 shows an example arrangement whereby satellite ephemeris information is broadcast for reception by a UE, according to the present disclosure.

FIG. 8 shows an example method of operating a communications device, according to the present disclosure.

FIG. 9 shows an example method of operating infrastructure equipment forming part of a NTN, according to the present disclosure.

### DETAILED DESCRIPTION OF THE EMBODIMENTS

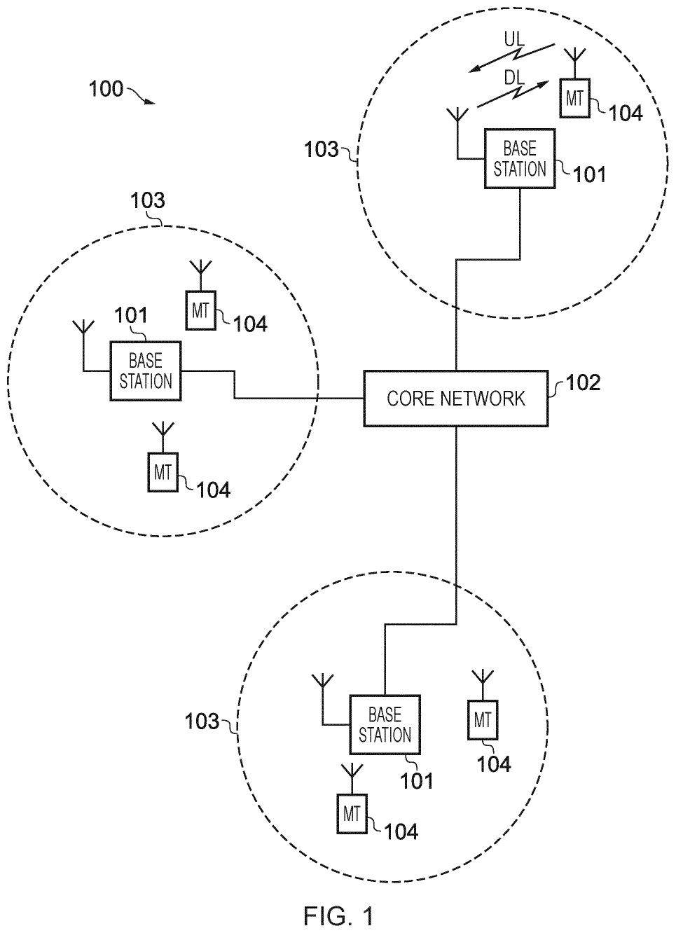

Long Term Evolution Advanced Radio Access Technology (4G) FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on.

Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs (eNB), g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

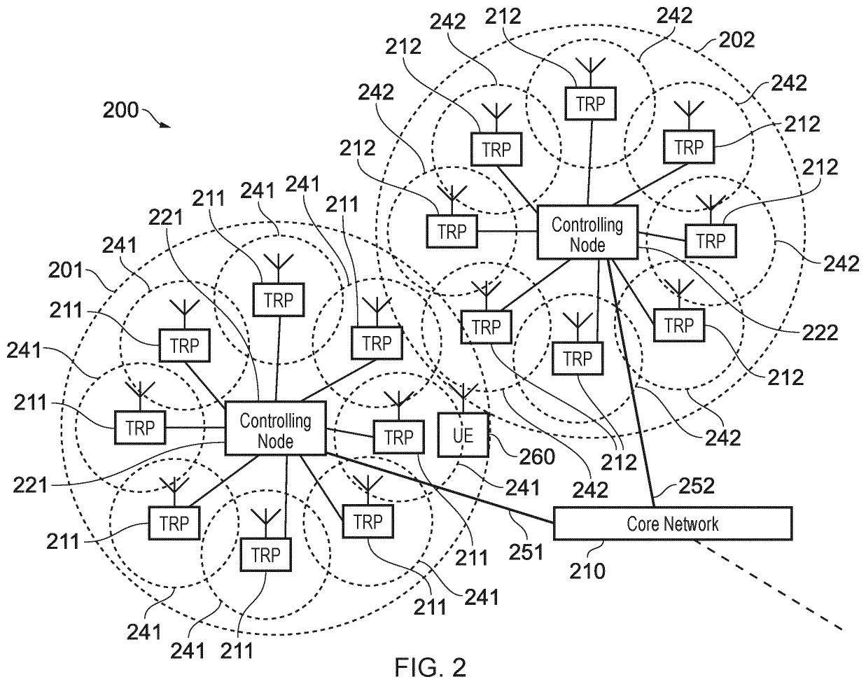

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

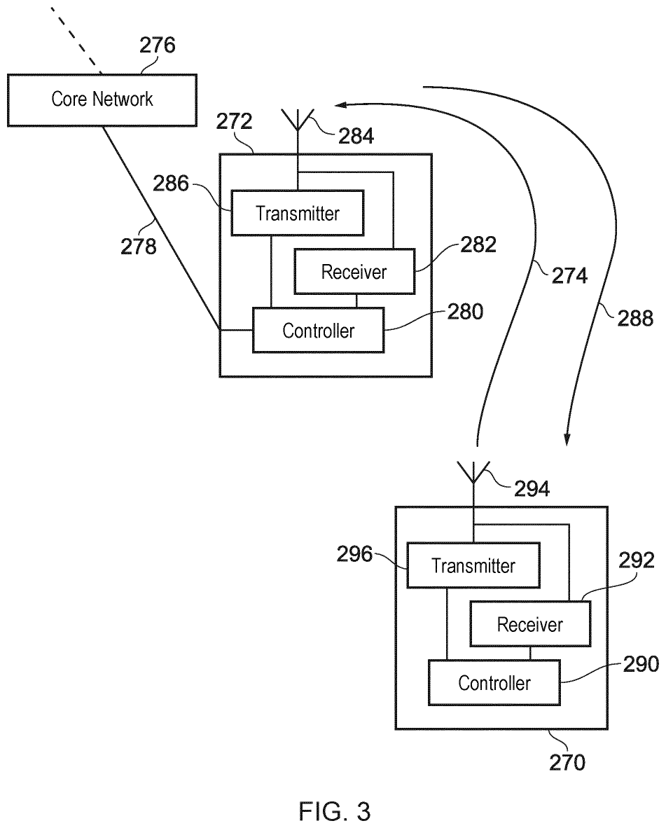

A more detailed illustration of a communications device 270 and an example network infrastructure equipment 272, which may be thought of as an eNB or a gNB 101 or a combination of a controlling node 221 and TRP 211, is presented in FIG. 3. As shown in FIG. 3, the communications device 270 is shown to transmit uplink data to the infrastructure equipment 272 of a wireless access interface as illustrated generally by an arrow 274. The UE 270 is shown to receive downlink data transmitted by the infrastructure equipment 272 via resources of the wireless access interface as illustrated generally by an arrow 288. As with FIGS. 1 and 2, the infrastructure equipment 272 is connected to a core network 276 (which may correspond to the core network 102 of FIG. 1 or the core network 210 of FIG. 2) via an interface 278 to a controller 280 of the infrastructure equipment 272. The infrastructure equipment 272 may additionally be connected to other similar infrastructure equipment by means of an inter-radio access network node interface, not shown on FIG. 3.

The infrastructure equipment 272 includes a receiver 282 connected to an antenna 284 and a transmitter 286 connected to the antenna 284. Correspondingly, the communications device 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the communications device 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, which may be non-volatile memory, operating according to instructions stored on a computer readable medium.

### Non-Terrestrial Networks (NTNs)

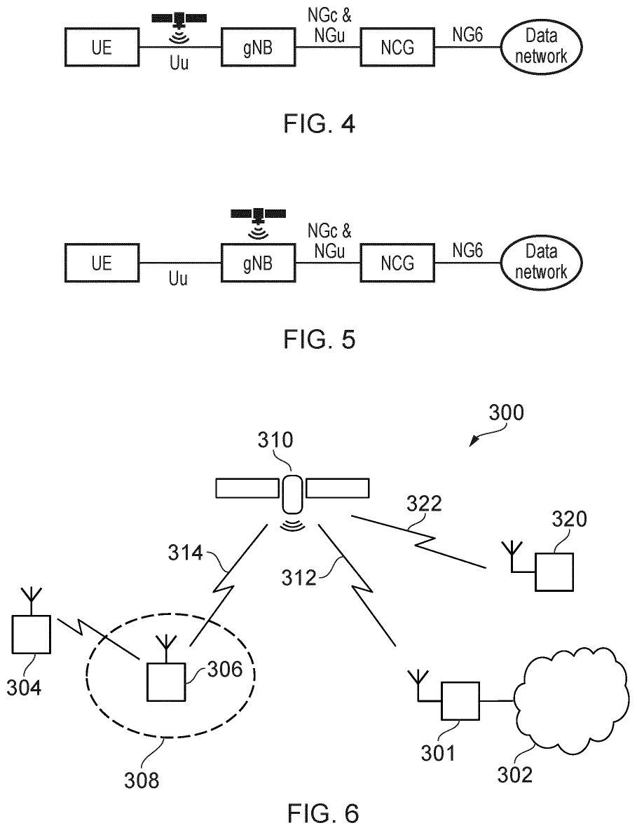

An overview of NR-NTN can be found in [1], and much of the following wording, along with FIGS. 4 and 5, has been reproduced from that document as a way of background.

As a result of the wide service coverage capabilities and reduced vulnerability of space/airborne vehicles to physical attacks and natural disasters, Non-Terrestrial Networks are expected to:
foster the roll out of 5G service in un-served areas that cannot be covered by terrestrial 5G network (isolated/remote areas, on board aircrafts or vessels) and underserved areas (e.g. sub-urban/rural areas) to upgrade the performance of limited terrestrial networks in a cost effective manner;
reinforce the 5G service reliability by providing service continuity for M2M/IoT devices or for passengers on board moving platforms (e.g. passenger vehicles-aircraft, ships, high speed trains, bus) or ensuring service availability anywhere especially for critical communications, future railway/maritime/aeronautical communications; and to
enable 5G network scalability by providing efficient multicast/broadcast resources for data delivery towards the network edges or even user terminal.

The benefits relate to either Non-Terrestrial Networks operating alone or to integrated terrestrial and Non-Terrestrial networks. They will impact at least coverage, user bandwidth, system capacity, service reliability or service availability, energy consumption and connection density. A role for Non-Terrestrial Network components in the 5G system is expected for at least the following verticals: transport, Public Safety, Media and Entertainment, eHealth, Energy, Agriculture, Finance and Automotive. It should also be noted that the same NTN benefits apply to 4G and/or LTE technologies and that while NR is sometimes referred to in the present disclosure, the teachings and techniques presented herein are equally applicable to 4G and/or LTE.

FIG. 4 illustrates a first example of an NTN architecture based on a satellite/aerial platform (which may be referred to as non-terrestrial infrastructure equipment) with a bent pipe payload, meaning that the same data is sent back down to Earth as is received by the satellite/aerial platform, with only frequency or amplification changing; i.e. acting like a pipe with a u-bend. In this example NTN, the satellite or the aerial platform will therefore relay a NR (or LTE) signal between the gNodeB (or eNodeB) and UEs in a transparent manner. In such examples, a UE may be considered to receive signals from the satellite, despite the fact that the signal originated from the gNodeB (or eNodeB), and that the satellite relays signals to the UE in a transparent manner.

FIG. 5 illustrates a second example of an NTN architecture based on a satellite/aerial platform (which may also be referred to as non-terrestrial infrastructure equipment) comprising a gNodeB (or eNodeB in the examples of this disclosure). In this example NTN, the satellite or aerial platform carries a full or part of a gNodeB to generate or receive a NR (or LTE) signal to/from the UEs. For example, in addition to frequency conversion and amplification, the satellite/aerial platform may also decode a received signal. This requires the satellite or aerial platform to have sufficient on-board processing capabilities to be able to include a gNodeB or eNodeB functionality.

FIG. 6 schematically shows an example of a wireless communications system 300 which may be configured to operate in accordance with embodiments of the present disclosure. The wireless communications system 300 in this example is based broadly around an LTE-type or 5G-type architecture. Many aspects of the operation of the wireless communications system/network 300 are known and understood and are not described here in detail in the interest of brevity. Operational aspects of the wireless communications system 300 which are not specifically described herein may be implemented in accordance with any known techniques, for example according to the current LTE-standards or the proposed 5G standards.

The wireless communications system 300 comprises a core network part 302 (which may be a 4G core network or a 5G core network) in communicative connection with a radio network part. The radio network part comprises a terrestrial station 301 connected to a non-terrestrial network part 310. The non-terrestrial network part 310 may be an example of infrastructure equipment. Alternatively, or in addition, the non-terrestrial network part 310 may be mounted on a satellite vehicle or on an airborne vehicle. In some cases, the base station (e.g. g-Node B/e-node B) may be fully implemented in the terrestrial station 301 or in the non-terrestrial network part 310, or may be partially implemented in one or both of the terrestrial station 301 or in the non-terrestrial network part 310.

The non-terrestrial network part 310 may communicate with a communications device 306, located within a cell 308, by means of a wireless access interface provided by a wireless communications link 314. For example, the cell 308 may correspond to the coverage area of a spot beam generated by the non-terrestrial network part 310. The boundary of the cell 308 may depend on an altitude of the non-terrestrial network part 310 and a configuration of one or more antennas of the non-terrestrial network part 310 by which the non-terrestrial network part 310 transmits and receives signals on the wireless access interface.

The non-terrestrial network part 310 may be a satellite in an orbit with respect to the Earth, or may be mounted on such a satellite. For example, the satellite may be in a geo-stationary earth orbit (GEO) such that the non-terrestrial network part 310 does not move with respect to a fixed point on the Earth's surface. The geo-stationary earth orbit may be approximately 36,786 km above the Earth's equator. The satellite may alternatively be in a low-earth orbit (LEO), in which the non-terrestrial network part 310 may complete an orbit of the Earth relatively quickly, thus providing moving cell coverage. Alternatively, the satellite may be in a non-geostationary orbit (NGSO), so that the non-terrestrial network part 310 moves with respect to a fixed point on the Earth's surface. The non-terrestrial network part 310 may be an airborne vehicle such as an aircraft, or may be mounted on such a vehicle. The airborne vehicle (and hence the non-terrestrial network part 310) may be stationary with respect to the surface of the Earth or may move with respect to the surface of the Earth.

In FIG. 6, the terrestrial base station 301 is shown as ground-based, and connected to the non-terrestrial network part 310 by means of a wireless communications link 312. The non-terrestrial network part 310 receives signals representing downlink data transmitted by the base station 301 on the wireless communications link 312 known as the feeder link and, based on the received signals, transmits signals representing the downlink data via the wireless communications link 314 known as the access link providing the wireless access interface for the communications device 306. Similarly, the non-terrestrial network part 310 receives signals representing uplink data transmitted by the communications device 306 via the wireless access interface comprising the wireless communications link 314 and transmits signals representing the uplink data to the terrestrial station 301 on the wireless communications link 312. The wireless communications links 312, 314 may operate at a same frequency, or may operate at different frequencies.

The extent to which the non-terrestrial network part 310 processes the received signals may depend upon a processing capability of the non-terrestrial network part 310. For example, the non-terrestrial network part 310 may receive signals representing the downlink data on the wireless communication link 312, amplify them and (if needed) re-modulate them onto an appropriate carrier frequency for onwards transmission on the wireless access interface provided by the wireless communications link 314. Alternatively, the non-terrestrial network part 310 may be configured to decode the signals representing the downlink data received on the wireless communication link 312 into un-encoded downlink data, re-encode the downlink data and modulate the encoded downlink data onto the appropriate carrier frequency for onwards transmission on the wireless access interface provided by the wireless communications link 314.

The non-terrestrial network part 310 may be configured to perform some of the functionality conventionally carried out by a base station (e.g. a gNodeB or an eNode B), such as base station 101 of FIG. 1. In particular, latency-sensitive functionality (such as acknowledging a receipt of the uplink data, or responding to a RACH request) may be performed by the non-terrestrial network part 310 partially implementing some of the functions of a base station.

As mentioned above, a base station may be co-located with the non-terrestrial network part 310; for example, both may be mounted on the same satellite vehicle or airborne vehicle, and there may be a physical (e.g. wired, or fibre optic) connection on board the satellite vehicle or airborne vehicle, providing the coupling between the terrestrial station 301 and the non-terrestrial network part 310. In such co-located arrangements, a wireless communications feeder link between the base station and a terrestrial station 301 may provide connectivity between the base station (co-located with the non-terrestrial network part 310) and the core network part 302.

The terrestrial station 301 may be an NTN Gateway that is configured to transmit signals to the terrestrial network part 310 via the wireless communications link 312 and to communicate with the core network part 302. That is, in some examples the terrestrial station 301 may not include base station functionality. For example, if the base station is co-located with the non-terrestrial network part 310, as described above, the terrestrial station 301 does not implement base station functionality. In other examples, the base station may be co-located with the NTN Gateway in the terrestrial station 301, such that the terrestrial station 301 is capable of performing base station (e.g. gNode B or eNodeB) functionality.

In some examples, even if the base station is not co-located with the non-terrestrial network part 310 (such that the base station functionality is implemented by a ground-based component), the terrestrial station 301 may not necessarily implement the base station functionality. In other words, the base station (e.g. gNodeB or eNodeB) may not be co-located with the terrestrial station 301 (NTN Gateway). In this manner, the terrestrial station 301 (NTN Gateway) transmits signals received from the non-terrestrial network part 310 to a base station (not shown in FIG. 6). In such an example, the base station (e.g. gNodeB or eNodeB) may be considered as being part of core network part 302, or may be separate (not shown in FIG. 6) from the core network part 302 and located logically between the terrestrial station 301 (NTN Gateway) and the core network part 302.

In some cases, the communications device 306 shown in FIG. 6 may be configured to act as a relay node. That is, it may provide connectivity to one or more terminal devices such as the terminal device 304. When acting as a relay node, the communications device 306 transmits and receives data to and from the terminal device 304, and relays it, via the non-terrestrial network part 310 to the terrestrial station 301. The communications device 306, acting as a relay node, may thus provide connectivity to the core network part 302 for terminal devices which are within a transmission range of the communications device 306.

In some cases, the non-terrestrial network part 310 is also connected to a ground station 320 via a wireless link 322. The ground station may for example be operated by the satellite operator (which may be the same as the mobile operator for the core and/or radio network or may be a different operator) and the link 322 may be used as a management link and/or to exchange control information. In some cases, once the non-terrestrial network part 310 has identified its current position and velocity, it can send position and velocity information to the ground station 320. The position and velocity information may be shared as appropriate, e.g. with one or more of the UE 306, terrestrial station 301 and base station, for configuring the wireless communication accordingly (e.g. via links 312 and/or 314).

It will be apparent to those skilled in the art that many scenarios can be envisaged in which the combination of the communications device 306 and the non-terrestrial network part 310 can provide enhanced service to end users. For example, the communications device 306 may be mounted on a passenger vehicle such as a bus or train which travels through rural areas where coverage by terrestrial base stations may be limited. Terminal devices on the vehicle may obtain service via the communications device 306 acting as a relay, which communicates with the non-terrestrial network part 310.

There is a need to ensure that connectivity for the communications device 306 with the base station 301 can be maintained, in light of the movement of the communications device 306, the movement of the non-terrestrial network part 310 (relative to the Earth's surface), or both. According to conventional cellular communications techniques, a decision to change a serving cell of the communications device 306 may be based on measurements of one or more characteristics of a radio frequency communications channel, such as signal strength measurements or signal quality measurements. In a terrestrial communications network, such measurements may effectively provide an indication that the communications device 306 is at, or approaching, an edge of a coverage region of a cell, since, for example, path loss may broadly correlate to a distance from a base station. However, such conventional measurement-based algorithms may be unsuitable for cells generated by means of the transmission of beams from a non-terrestrial network part, such as the cell 308 generated by the non-terrestrial network part 310. In particular, path loss may be primarily dependent on an altitude of the non-terrestrial network part 310 and may vary only to a very limited extent (if at all) at the surface of the Earth, within the coverage region of the cell 308. As a result, the strength of a received signal may be always lower than that from a terrestrial base station, which thus will always be selected when available.

A further challenge of conventional techniques may be the relatively high rate at which cell changes occur for the communications device 306 obtaining service from one or more non-terrestrial network parts. For example, where the non-terrestrial network part 310 is mounted on a satellite in a low-earth orbit (LEO), the non-terrestrial network part 310 may complete an orbit of the Earth in around 90 minutes; the coverage of a cell generated by the non-terrestrial network part 310 will move very rapidly, with respect to a fixed observation point on the surface of the Earth. Similarly, it may be expected that the communications device 306 may be mounted on an airborne vehicle itself, having a ground speed of several hundreds of kilometres per hour.

### Satellite Positional Information

One particular difficulty associated with NGSO NTNs is the large distances and relative speeds between the UE and the gNB compared to terrestrial networks. For example, if a non-terrestrial network part is mounted on a satellite in LEO, the distance between the non-terrestrial network part and the UE may be between 600 km to 1200 km. Hence, the propagation delay between the UE (hereinafter the term UE is used to refer to any communications device configured to communicate with a non-terrestrial part of an NTN) and the gNB is significantly larger than for terrestrial networks, particularly in a ‘transparent’ arrangement such as that shown in FIG. 4. For example, for an NTN using a transparent LEO satellite, the Round Trip Time (RTT) between the UE and the gNB may be between approximately 8 ms to approximately 26 ms.

In order to take into account this large propagation delay, uplink transmissions would need to apply a large Timing Advance (TA) and the gNB would need to take this into account for scheduling of uplink data. The timing advance that needs to be applied depends on the location of the UE within the cell footprint of the satellite. Since the cell footprint can be large, there can be a large variation of the timing advance that needs to be applied, depending on the UE location within the cell footprint.

In addition to the increased RTT between the UE and the gNB, the NTN system also needs to take into account the movement of the satellite. For example, a LEO satellite can be travelling at 7.56 km/second (27,216 km/h) relative to the UE, which would cause significant Doppler shift that the UE needs to compensate for. In order to factor in the Doppler shift, i.e. perform pre-compensation for the frequency of the uplink transmissions, the UE needs to know its own geo-location and the motion (e.g. position and velocity) of the satellite. The geo-location of the UE can, for example, be obtained from Global Navigation Satellite System (GNSS) or from any other suitable means.

The position and velocity of the satellite can be derived from the satellite ephemeris information, that is the satellite orbital trajectory, which can be periodically broadcast to the UE, e.g. via System Information Blocks (SIBs). However, broadcasting ephemeris information, e.g. every 100 ms, can lead to high signaling overhead.

Furthermore, signaling ephemeris information does not take into account perturbations in the satellite orbit and hence may not provide sufficient accuracy to determine the required timing advance and frequency compensation. In particular, satellites in LEO do not exist in a perfect vacuum and thus experience a number of factors such as varying drag coefficients, gravitational forces which perturb the orbit of the satellite, or a satellite intentionally moving to a higher or lower orbit using its own propulsion means. As such, as the time since a UE last received a periodic broadcast of the satellite ephemeris information increases, the accuracy with which the UE can determine the position and velocity of the satellite decreases. Consequently, ephemeris information broadcast via the SIBs has a limited time in which it is valid (i.e. accurate) and therefore requires renewal (i.e. updating) after a certain period of time.

Accordingly, the gNB or an NTN Gateway can derive the satellite position and velocity and repeatedly broadcast it via the SIBs. The satellite position and velocity may be determined by the gNB or NTN Gateway, for example, via GNSS or other suitable means. The gNB or NTN Gateway may determine the satellite position and velocity via communications on the network itself, or the gNB or NTN Gateway may determine the satellite position and velocity by other means, separate from the network. For example, the gNB or NTN Gateway may derive the satellite position and velocity, e.g. via a telemetry link to the satellite, and the gNB may transmit that information in the SIBs. Hereinafter, the term ‘gNB’ is used to refer to any of a base station, a gNB, an eNB or an NTN gateway, unless explicitly stated otherwise.

The repetition of the SIB allows any UE to decode the system information (SI) included in the SIB (including the ephemeris information) whenever the UE needs it. When the ephemeris information requires updating (for example due to its validity time expiring), the SI may be modified to include updated ephemeris information. When the SI is modified in this way, UEs may be made aware that the content of the SI has changed. Accordingly, a UE that has been made aware that the content of the SIB has changed may re-read the content of the SIB when it requires the ephemeris information (for example for UL synchronization purposes). In other words, a UE having read the content of the SIB once, for example during initial access, is not expected to read the content of the SIB again unless it has received a notification that the content of the SIB has changed. This helps the UE to save battery power.

In an NTN, the ephemeris information is repeatedly broadcast on SIBs for any UE in need of the information to read. Since the ephemeris information becomes stale and needs to be updated after a certain period of time, it is useful for a UE that reads the SIB to also know how long the information read will remain valid. This is especially useful for UEs in RRC-IDLE or RRC-INACTIVE mode as they are able to avoid re-reads of the system information whilst ensuring that the ephemeris information they store is still valid. This equally applies to UEs in RRC-CONNECTED or DRX mode or UEs currently in a handover process.

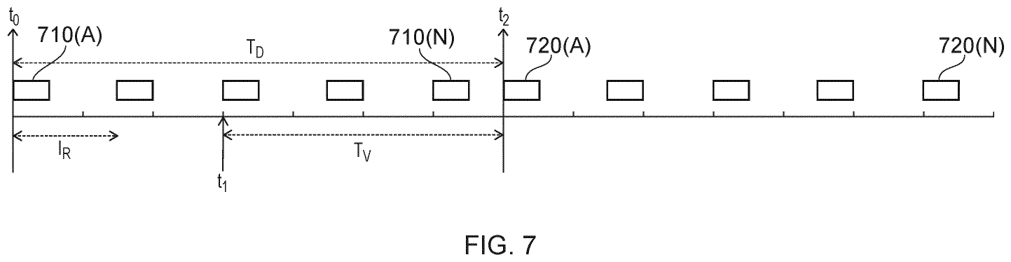

FIG. 7 shows an example of an arrangement whereby the SI may include information indicative of a time at which the ephemeris information will become invalid. At time t₀, a gNB generates satellite ephemeris information (for example based on GNSS or using any other suitable means to derive the satellite's position) and broadcasts this ephemeris information within the SI of periodic SIBs 710(A)-710(N). The time t₀ may be regarded as the time at which the satellite ephemeris information was generated by the gNB, or the time at which the first SIB 710(A) including the satellite ephemeris information was broadcast. Once the ephemeris information becomes invalid, the gNB modifies the SI included within the SIBs 720(A)-720(N) to include updated ephemeris information, which can be read by UEs when required. This updated ephemeris information may be different to the previous ephemeris information. Alternatively, in some cases the updated ephemeris information may be partially or fully identical to the previous ephemeris information. For example, the satellite's actual motion may have been in close agreement with the previous ephemeris information, such that no changes to the ephemeris information is necessary.

In this example, the SI additionally includes the overall validity duration (T_{D}), which indicates the duration, from t₀, for which the ephemeris information is deemed to be valid. Therefore, when a UE reads and stores the SI (and hence ephemeris information) at a time t₁ (shown by the vertical arrow labelled t₁), the UE is able to calculate a remaining validity time (T_{V}) (i.e. the remaining time until the ephemeris information becomes invalid), via Equation 1 below:

$${T}_{v} = {T}_{D} - ( {t}_{1} - {t}_{0} ) \qquad ( 1 )$$

The duration T_{V} may, for example, be used to set the countdown of a timer in the UE, whose expiry would then cause the UE to determine that the ephemeris information has become invalid, and consequently read updated ephemeris information from a SIB. As a result of the above, a UE is able to determine when the ephemeris information it stores will become invalid and subsequently acquire updated ephemeris information, when required. When the ephemeris information becomes invalid, the gNB generates updated ephemeris information (for example in the same way the previous ephemeris information was calculated) at a second generation time (t₂) and updates the SI to include the updated ephemeris information. As shown in FIG. 7, the period between consecutive SIBs (I_{R}) including the same ephemeris information may be constant, however the period between consecutive SIBs including different ephemeris information (i.e. the period between SIB 710(N) and SIB 720(A) may be less than I_{R}. In particular, the ephemeris information may become invalid before expiry of a particular SIB period. Accordingly, gNB may begin broadcasting the updated ephemeris information within SIB 720(A), before expiry of the particular SIB period, for example immediately upon expiry of the ephemeris information.

The SI may additionally include time t₀ to allow UEs to calculate T_{V} using Equation 1 above. Alternatively, in some examples the SI may not include to. In such examples, in particular when SIBs are broadcast at regular intervals, a UE may be provided with information regarding the SIB that includes the current ephemeris information (i.e. its repetition number (M)), and thus may be able to calculate to based on this information. For example, if a UE knows the period (I_{R}) between SIB repetitions as well as what number SIB repetition it is reading (e.g. the UE knows it is reading the third repetition of the SIB carrying the ephemeris information, as shown in FIG. 7) with the same ephemeris information), the UE may calculate when the first SIB with the current ephemeris information was broadcast using Equation 2 below:

$${t}_{0} = {t}_{1} - {MI}_{R} \qquad ( 2 )$$

In such examples, the repetition number (M) of the SIB that includes the current ephemeris information, may be made available to UEs in a number of different ways. For example, the repetition number could be included in a downlink control information (DCI) message that schedules a physical downlink shared channel (PDSCH) carrying the relevant SIB, or in a demodulation reference signal (DM-RS) initialisation for the PDSCH carrying the relevant SIB, or through any other suitable means. As such, UEs may receive the repetition number in many different ways. UEs may also receive the repetition period (I_{R}) between SIBs that contain the same SI content. For example, this may be specified in advance, or may be communicated to the UE in a number of different ways, for example within the SI.

In the above examples, particular events are discussed in relation to times (for example T_{V}, T_{D}, t₁, and t₀). While these times may be absolute times (e.g. GNSS times) the times may equally correspond to a frame number, subframe number or a slot number. For example, for systems in which T_{D} is less than the superframe duration of 10240 ms, t₀ can be the System Frame Number (SFN) of the frame in which the first SIB carrying the ephemeris information is broadcast. In this case, t₁ would then be the SFN of the frame at the base station at the time when the UE reads the SIB carrying the ephemeris information. This can be calculated as set out in Equation 3 below:

$${t}_{1} = {t}_{0} + M \times {I}_{R} + RTT / 2 \qquad ( 3 )$$

where RT is the round-trip time between the base station and the UE, and all terms in the equation are in frame times. In these examples, the UE-calculated validity time T_{V} has units of frames and any validity timer counts down frame boundaries. In some examples, T_{D} may be significantly larger than RTT. For example, T_{D} may be on the order of 100s of seconds, while in LEO satellite constellations RTT may be in the order of 10s of milliseconds. Therefore, when T_{D} is significantly larger than RTT (for example when T_{D} is two or more, three or more, or four or more orders of magnitude longer than RTT), RTT may be approximated to be zero in Equation 3 above. This is particularly advantageous when the precise value of RTT is not known.

In some examples, the time t₀ may be the subframe or slot number in which the SIB carrying the ephemeris information is initially broadcast. In this case, t₁ is then the subframe or slot number at the base station at the time when the UE reads the SIB carrying the ephemeris information, and can be calculated using Equation 3 above, where all terms in Equation 3 are subframe or slot times. In this example, the UE-calculated T_{V} has units of subframes or slots and any validity timer counts down subframe or slot boundaries. The validity of the ephemeris information is likely to exceed a frame duration of 10 ms, and as such subframe “n” in a given frame would be counted as: [(10×SFN+n) mod 10240]. Equivalent calculations apply to slots.

While in the above example T_{D} is included within the SI, in some alternative examples, the gNB may include the time t₂ itself within the SIB. Accordingly, the UE can be directly informed of time t₂ and thus knows when its stored ephemeris information will become invalid.

In some examples, the calculated remaining validity time (T_{V}) may extend beyond the second generation time (t₂). In this manner, the ephemeris information included in SIBs 710(A)-(N) may be considered to be valid after new ephemeris information has been broadcast as part of SIB 720(A). In other words, the gNB may broadcast the updated ephemeris information within SIB 720(A) before the ephemeris information within SIBs 710(A)-(N) has expired.

In some examples, UEs may be notified that the ephemeris information has become invalid earlier than anticipated, for example due to an unexpected movement of the satellite (i.e. the satellite has fired its thrusters to avoid an in-orbit collision). In particular, the gNB may transmit a signal to a UE indicating that the ephemeris information has become invalid. This signal could be transmitted to the UE in any suitable manner. The UE may then determine that the ephemeris information has become invalid based on this transmission from the gNB. Accordingly, the UE may then read the next SIB from the gNB in order to obtain updated ephemeris information.

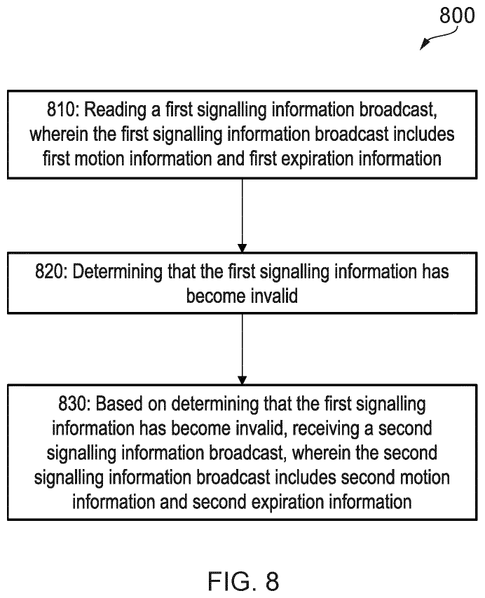

FIG. 8 shows an example method 800 of operating a communications device configured to transmit uplink signals to and/or to receive downlink signals from a non-terrestrial infrastructure equipment forming part of NTN via a terrestrial infrastructure equipment. Step 810 of the method includes reading a first signalling information broadcast, wherein the first signalling information broadcast includes first motion information and expiration information. In particular, the first motion information and expiration information may be included in first signalling information included in the first signalling information broadcast. The first motion information is first motion information of the non-terrestrial infrastructure equipment and the expiration information is indicative of an invalidity time at which the first motion information will be deemed to be invalid. The method proceeds to step 820 of determining that the first signalling information has become invalid, for example based on the first expiration information. The method then proceeds to step 830 of, based on determining that the first signalling information has become invalid, receiving a second signalling information broadcast, wherein the second signalling information broadcast includes second signalling information comprising second motion information of the non-terrestrial infrastructure equipment and second expiration information of the second motion information.

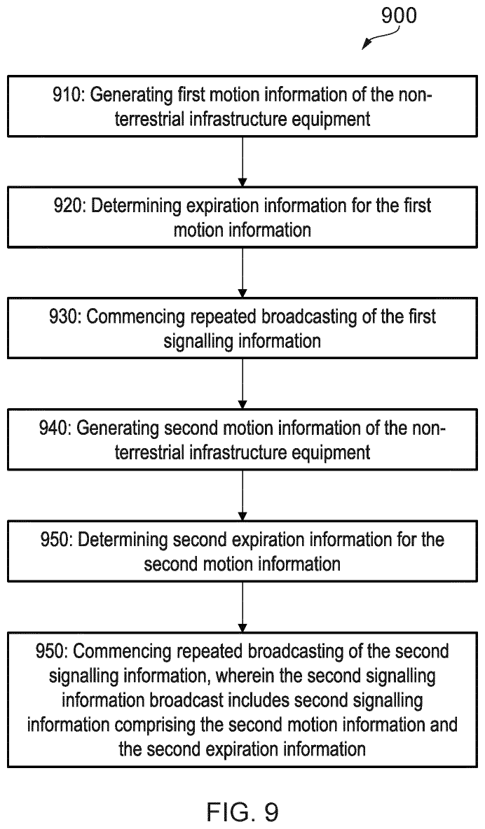

FIG. 9 shows an example method 900 of operating infrastructure equipment forming part of an NTN. The method includes step 910 of generating first motion information of the non-terrestrial infrastructure equipment. The method further includes step 920 of determining expiration information for the first motion information, wherein the expiration information is indicative of an invalidity time at which the first motion information will be deemed to be invalid. The method then proceeds to step 930 of commencing repeated broadcasting of the first signalling information, wherein a first signalling information broadcast includes first signalling information comprising: the first motion information, and the expiration information. The method then proceeds to step 940 of generating second motion information of the non-terrestrial infrastructure equipment. The method further includes step 950 of determining second expiration information for the second motion information, wherein the second expiration information is indicative of an invalidity time at which the second motion information will be deemed to be invalid. The method further includes step 960 of commencing repeated broadcasting of the second signalling information, wherein the second signalling information broadcast includes second signalling information comprising the second motion information and the second expiration information.

Further particular and preferred aspects of the present invention are set out in the accompanying independent and dependent claims. It will be appreciated that features of the dependent claims may be combined with features of the independent claims in combinations other than those explicitly set out in the claims.

Further examples of feature combinations taught by the present disclosure are set out in the following numbered clauses:

1. A method of operating a communications device configured to transmit uplink signals to and/or to receive downlink signals from a non-terrestrial infrastructure equipment forming part of a non-terrestrial network, NTN, the method comprising:
reading a first signalling information broadcast by an infrastructure equipment at a first reception time, wherein the first signalling information broadcast includes first signalling information comprising:
first motion information of the non-terrestrial infrastructure equipment, and
first expiration information, wherein the first expiration information is indicative of an invalidity time at which the first motion information will be deemed to be invalid;
   determining that the first motion information has become invalid; and
based on determining that the first motion information has become invalid, receiving a second signalling information broadcast, wherein the second signalling information broadcast includes second signalling information comprising:
second motion information of the non-terrestrial infrastructure equipment, and
second expiration information, wherein the second expiration information is indicative of an invalidity time at which the second motion information will be deemed to be invalid.

2. The method of claim 1, wherein the second motion information is different to the first motion information.

3. The method of claim 1 or 2, further comprising determining, based on the first expiration information, the invalidity time or a remaining validity duration, the remaining validity duration being a duration between the first reception time and the invalidity time.

4. The method of claim 3, wherein the first expiration information includes an overall validity duration,
wherein the overall validity duration is a duration, from a first broadcast time, for which the first motion information is valid, and
wherein the first broadcast time is a time at which the first signalling information was first broadcasted by the infrastructure equipment.

5. The method of claim 4, further comprising determining, based on the first signalling information, the first broadcast time.

6. The method of claim 5, wherein determining the first broadcast time comprises one or more of:
detecting the first broadcast time from the first signalling information, wherein the first signalling information indicates the first broadcast time; and
detecting a repetition number or transmission number of the first signalling information associated with the first signalling information broadcast.

7. The method of claim 5 or 6, comprising determining the remaining invalidity time based on the overall validity time, the first broadcast time, and the first reception time.

8. The method of any of claims 3-7, wherein the determining the invalidity time or a remaining validity duration is based on a repetition number of the first signalling information broadcast read by the communications device, and a period between consecutive first signalling information broadcasts.

9. The method of claim 8, wherein the repetition number is included in the first signalling information.

10. The method of claim 8 or claim 9, further comprising:
receiving, from the infrastructure equipment, a first transmission, wherein the first transmission is separate from the first signalling information broadcast, and wherein the first transmission includes the repetition number.

11. The method of claim 10, wherein the first transmission is contained in one or more of:
a downlink control information message; and
a demodulation reference signal.

12. The method of any preceding claim, wherein the expiration information includes the invalidity time.

13. The method of any preceding claim, further comprising configuring a countdown timer to the invalidity time, based on the first expiration information, wherein determining that the first signalling information has become invalid is based on expiry of the countdown timer.

14. The method of any preceding claim, further comprising:
receiving, from the infrastructure equipment, a notification that indicates that the first motion information has become invalid;
wherein the determining that the first motion information has become invalid is based on the received notification.

15. A communication device comprising:
a transceiver configured to transmit uplink signals to and/or to receive downlink signals from a non-terrestrial infrastructure equipment forming part of a non-terrestrial network, NTN; and
a controller configured in combination with the transceiver to
   read a first signalling information broadcast by an infrastructure equipment at a first reception time, wherein the first signalling information broadcast includes first signalling information comprising:
first motion information of the non-terrestrial infrastructure equipment, and
expiration information, wherein the expiration information is indicative of an invalidity time at which the first motion information will be deemed to be invalid;
determine that the first motion information has become invalid; and
based on determining that the first motion information has become invalid, receive a second signalling information broadcast, wherein the second signalling information broadcast includes second signalling information comprising:
second motion information of the non-terrestrial infrastructure equipment, and
second expiration information, wherein the second expiration information is indicative of an invalidity time at which the second motion information will be deemed to be invalid.

16. Circuitry for a communications device, the circuitry comprising:
transceiver circuitry configured to transmit uplink signals to and/or to receive downlink signals from a non-terrestrial infrastructure equipment forming part of a non-terrestrial network, NTN; and
controller circuitry configured in combination with the transceiver to
   read a first signalling information broadcast by an infrastructure equipment at a first reception time, wherein the first signalling information broadcast includes first signalling information comprising:
first motion information of the non-terrestrial infrastructure equipment, and
expiration information, wherein the expiration information is indicative of an invalidity time at which the first motion information will be deemed to be invalid;
determine that the first motion information has become invalid; and
based on determining that the first motion information has become invalid, receive a second signalling information broadcast, wherein the second signalling information broadcast includes second signalling information comprising:
second motion information of the non-terrestrial infrastructure equipment, and
second expiration information, wherein the second expiration information is indicative of an invalidity time at which the second motion information will be deemed to be invalid.

17. A method of operating infrastructure equipment forming part of a non-terrestrial network, NTN, the method comprising:
generating first motion information of the non-terrestrial infrastructure equipment;
determining first expiration information for the first motion information, wherein the first expiration information is indicative of an invalidity time at which the first motion information will be deemed to be invalid;
commencing, at a first broadcast time, repeated broadcasting of the first signalling information, wherein a first signalling information broadcast includes first signalling information comprising:
the first motion information, and
the first expiration information;
   generating second motion information of the non-terrestrial infrastructure equipment;
determining second expiration information for the second motion information, wherein the second expiration information is indicative of an invalidity time at which the second motion information will be deemed to be invalid; and
commencing, at a second broadcast time, repeated broadcasting of the second signalling information, wherein the second signalling information broadcast includes second signalling information comprising: the second motion information and the second expiration information.

18. The method of claim 17, wherein the second motion information is different to the first motion information.

19. The method of claim 17 or claim 18, wherein the first and second expiration information each includes an overall validity duration,
wherein the overall validity duration is a duration, from the first or second broadcast time respectively, for which the respective first or second motion information is valid.

20. The method of any of claims 17-19, wherein the first signalling information includes one or more of:
the first broadcast time, and
a repetition number or transmission number of the first signalling information associated with the first signalling information broadcast.

21. The method of claim 20, wherein the first signalling information includes the repetition number.

22. The method of claim 20 or claim 21, further comprising:
transmitting, to a communications device, a first transmission separate from the first signalling information broadcast, wherein the first transmission includes the repetition number.

23. The method of claim 22, wherein the first transmission is contained in one or more of:
a downlink control information message; and
a demodulation reference signal.

24. The method of any one of claims 17 to 23, wherein the expiration information includes the invalidity time.

25. The method of any one of claims 17 to 24, further comprising:
transmitting, to a communications device, a notification that indicates that the first or second motion information has become invalid.

26. The method of any of claims 17-25, wherein the second broadcast time is at or after the invalidity time for the first expiration information.

27. The method of any of claims 17-26, wherein the second broadcast time is prior to the invalidity time for the first expiration information.

28. Infrastructure equipment for use in a non-terrestrial network, NTN, wherein the infrastructure equipment comprises:
a transceiver configured to transmit downlink signals to and/or receive uplink signals from one or more communications devices; and
   a controller configured in combination with the transceiver to
generate first motion information of the non-terrestrial infrastructure equipment;
   determine first expiration information for the first motion information, wherein the first expiration information is indicative of an invalidity time at which the first motion information will be deemed to be invalid;
   commence repeated broadcasting of the first signalling information, wherein a first signalling information broadcast includes first signalling information comprising:
   the first motion information, and
   the expiration information;
generate second motion information of the non-terrestrial infrastructure equipment;
   determine second expiration information for the second motion information, wherein the second expiration information is indicative of an invalidity time at which the second motion information will be deemed to be invalid; and
   commence repeated broadcasting of the second signalling information, wherein the second signalling information broadcast includes second signalling information comprising the second motion information and the second expiration information.

29. Circuity for infrastructure equipment for use in a non-terrestrial network, NTN, the circuitry comprising:
transceiver circuitry configured to transmit downlink signals to and/or receive uplink signals from one or more communications devices; and
controller circuitry configured in combination with the transceiver circuitry to
generate first motion information of the non-terrestrial infrastructure equipment;
determine expiration information for the first motion information, wherein the expiration information is indicative of an invalidity time at which the first motion information will be deemed to be invalid;
commence repeated broadcasting of the first signalling information, wherein a first signalling information broadcast includes first signalling information comprising:
the first motion information, and
the expiration information;
   generate second motion information of the non-terrestrial infrastructure equipment;
determine second expiration information for the second motion information, wherein the second expiration information is indicative of an invalidity time at which the second motion information will be deemed to be invalid; and
commence repeated broadcasting of the second signalling information, wherein the second signalling information broadcast includes second signalling information comprising the second motion information and the second expiration information.

### REFERENCES

[1] TR 38.811, “Study on New Radio (NR) to support non terrestrial networks (Release 15)”, 3rd Generation Partnership Project, December 2017.
[2] Holma H. and Toskala A, “LTE for UMTS OFDMA and SC-FDMA based radio access”, John Wiley and Sons, 2009.

1. A method of operating a communications device configured to transmit uplink signals to and/or to receive downlink signals from a non-terrestrial infrastructure equipment forming part of a non-terrestrial network, NTN, the method comprising:
reading a first signalling information broadcast by an infrastructure equipment at a first reception time, wherein the first signalling information broadcast includes first signalling information comprising:
first motion information of the non-terrestrial infrastructure equipment, and
first expiration information, wherein the first expiration information is indicative of an invalidity time at which the first motion information will be deemed to be invalid;
determining that the first motion information has become invalid; and
based on determining that the first motion information has become invalid, receiving a second signalling information broadcast, wherein the second signalling information broadcast includes second signalling information comprising:
second motion information of the non-terrestrial infrastructure equipment, and
second expiration information, wherein the second expiration information is indicative of an invalidity time at which the second motion information will be deemed to be invalid.

2. The method of claim 1, further comprising determining, based on the first expiration information, the invalidity time or a remaining validity duration, the remaining validity duration being a duration between the first reception time and the invalidity time.

3. The method of claim 2, wherein the first expiration information includes an overall validity duration,
wherein the overall validity duration is a duration, from a first broadcast time, for which the first motion information is valid, and
wherein the first broadcast time is a time at which the first signalling information was first broadcasted by the infrastructure equipment.

4. The method of claim 3, further comprising determining, based on the first signalling information, the first broadcast time.

5. The method of claim 4, wherein determining the first broadcast time comprises one or more of:
detecting the first broadcast time from the first signalling information, wherein the first signalling information indicates the first broadcast time; and
detecting a repetition number or transmission number of the first signalling information associated with the first signalling information broadcast.

6. The method of claim 4, comprising determining the remaining invalidity time based on the overall validity time, the first broadcast time, and the first reception time.

7. The method of claim 2, wherein the determining the invalidity time or a remaining validity duration is based on a repetition number of the first signalling information broadcast read by the communications device, and a period between consecutive first signalling information broadcasts.

8. The method of claim 1, further comprising configuring a countdown timer to the invalidity time, based on the first expiration information, wherein determining that the first signalling information has become invalid is based on expiry of the countdown timer.

9. The method of claim 1, further comprising:
receiving, from the infrastructure equipment, a notification that indicates that the first motion information has become invalid;
wherein the determining that the first motion information has become invalid is based on the received notification.

10. A communication device comprising:
a transceiver configured to transmit uplink signals to and/or to receive downlink signals from a non-terrestrial infrastructure equipment forming part of a non-terrestrial network, NTN; and
a controller configured in combination with the transceiver to
read a first signalling information broadcast by an infrastructure equipment at a first reception time, wherein the first signalling information broadcast includes first signalling information comprising:
first motion information of the non-terrestrial infrastructure equipment, and
expiration information, wherein the expiration information is indicative of an invalidity time at which the first motion information will be deemed to be invalid;
determine that the first motion information has become invalid; and
based on determining that the first motion information has become invalid, receive a second signalling information broadcast, wherein the second signalling information broadcast includes second signalling information comprising:
second motion information of the non-terrestrial infrastructure equipment, and
second expiration information, wherein the second expiration information is indicative of an invalidity time at which the second motion information will be deemed to be invalid.

11. (canceled)

12. A method of operating infrastructure equipment forming part of a non-terrestrial network, NTN, the method comprising:
generating first motion information of the non-terrestrial infrastructure equipment;
determining first expiration information for the first motion information, wherein the first expiration information is indicative of an invalidity time at which the first motion information will be deemed to be invalid;
commencing, at a first broadcast time, repeated broadcasting of the first signalling information, wherein a first signalling information broadcast includes first signalling information comprising:
the first motion information, and
the first expiration information;
generating second motion information of the non-terrestrial infrastructure equipment;
determining second expiration information for the second motion information, wherein the second expiration information is indicative of an invalidity time at which the second motion information will be deemed to be invalid; and
commencing, at a second broadcast time, repeated broadcasting of the second signalling information, wherein the second signalling information broadcast includes second signalling information comprising: the second motion information and the second expiration information.

13. The method of claim 12, wherein the first and second expiration information each includes an overall validity duration,
wherein the overall validity duration is a duration, from the first or second broadcast time respectively, for which the respective first or second motion information is valid.

14. The method of claim 12, wherein the first signalling information includes one or more of:
the first broadcast time, and
a repetition number or transmission number of the first signalling information associated with the first signalling information broadcast.

15. The method of claim 12, further comprising:
transmitting, to a communications device, a notification that indicates that the first or second motion information has become invalid.

16.-20. (canceled)

21. The method of claim 12, wherein the second broadcast time is at or after the invalidity time for the first expiration information.

22. The method of claim 12, wherein the second broadcast time is prior to the invalidity time for the first expiration information.
